(19) United States
(12) Patent Application Publication
(10) Pub. No.: US 2012/0154122 A1
(43) Pub. Date: Jun. 21, 2012

(54) METHOD AND APPARATUS OF RADIO FREQUENCY TESTING

(75) Inventors: Min-Kao Hong, Taichung City (TW); Po-Kuang Chang, Taoyuan County (TW); Shang-Sian You, Taichung City (TW); Kuo-Chang Hsu, Hsinchu County (TW)

(73) Assignee: INDUSTRIAL TECHNOLOGY RESEARCH INSTITUTE, Hsinchu (TW)

(21) Appl. No.: 13/012,807

(22) Filed: Jan. 25, 2011

(30) Foreign Application Priority Data
Dec. 16, 2010 (TW) 99144308

(51) Int. Cl. G06K 7/01

(52) U.S. Cl. 340/10.5

(57) ABSTRACT

A method and an apparatus of radio frequency (RF) testing are provided. The present method includes the following steps. A receiver and a transmitting antenna of a transmitter are controlled to move towards a direction, wherein the transmitter transmits a wireless signal to the receiver through the transmitting antenna. A specific power is measured every time when one of a plurality of predetermined sampling points is reached. In the foregoing moving and measuring steps, the relative distance and relative azimuth angle between the receiver and the transmitting antenna remain unchanged, and the frequency of the wireless signal also remains unchanged.

### CROSS-REFERENCE TO RELATED APPLICATION

This application claims the priority benefit of Taiwan application serial no. 99144308, filed on Dec. 16, 2010. The entirety of the above-mentioned patent application is hereby incorporated by reference herein and made a part of this specification.

### BACKGROUND OF THE INVENTION

1. Technical Field

The disclosure relates to a method and an apparatus of radio frequency (RF) testing.

2. Background

Radio frequency (RF) testing is always performed in some industries. For example, radio frequency identification (RFID) tags are usually attached to different products by suppliers of the products or staffs in large supermarkets. However, because the performance of RFID tags is easily affected by different products, different types of tags have to be used and they have to be attached to different positions in order to meet the requirement of different products. The starting power testing performed on RFID tags is critical to those in the industry. Herein “starting power” refers to a threshold, and when a RFID tag reader issues a signal to a RFID tag, the RFID tag is started and issues a response signal as long as the power of the signal received by the RFID tag reaches the starting power of RFID tag.

The most ideal environment for performing RF testing is anechoic chamber. This is because absorbers in an anechoic chamber can prevent measurement error caused by reflection and scattering of a RF signal during the transmission of the RF signal. However, the deployment of an anechoic chamber is very costly and special equipments and skilled workers are required for operating the anechoic chamber. Even a rented anechoic chamber incurs a high cost and limitations in the location and timing.

If the RF testing is not done within an anechoic chamber but in less ideal environments, some errors may be produced and different test results may be rendered in different environments or under different conditions.

### SUMMARY

According to embodiments of the disclosure, a method and an apparatus of radio frequency (RF) testing are provided for resolving aforementioned problem of testing outside anechoic chamber.

The disclosure provides a RF testing method including following steps. A receiver and a transmitting antenna of a transmitter are controlled to move towards a direction, wherein the transmitter transmits a wireless signal to the receiver through the transmitting antenna. A specific power is measured every time when one of a plurality of predetermined sampling points is reached, wherein the specific power is a minimum transmitting power of the transmitter which allows the receiving power of the receiver for receiving the wireless signal to reach a threshold, or the specific power is the receiving power of the receiver for receiving the wireless signal when the transmitter transmits the wireless signal with a fixed power. In foregoing moving and measuring steps, the relative distance and relative azimuth angle between the receiver and the transmitting antenna remain unchanged, and the frequency of the wireless signal also remains unchanged.

The disclosure also provides a RF testing apparatus including a carrier, a transmitting antenna of a transmitter, a driving module, and a control unit. A receiver is fastened on the carrier. The transmitter transmits a wireless signal to the receiver through the transmitting antenna. The driving module drives the carrier and the transmitting antenna to move towards a direction according to instructions of the control unit. The control unit measures aforementioned specific power every time when one of a plurality of predetermined sampling points is reached. During foregoing moving and measuring procedures, the relative distance and relative azimuth angle between the receiver and the transmitting antenna remain unchanged, and the frequency of the wireless signal also remains unchanged.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a flowchart of a radio frequency (RF) testing method according to an embodiment of the disclosure.

FIG. 2 is a diagram illustrating a test environment according to an embodiment of the disclosure.

FIG. 3 is a diagram of a RF testing apparatus according to an embodiment of the disclosure.

FIG. 4 is a flowchart of a RF testing method according to another embodiment of the disclosure.

FIG. 5 and FIG. 6 are diagrams illustrating how a specific power is measured according to an embodiment of the disclosure.

FIG. 7 is a flowchart of a RF testing method according to another embodiment of the disclosure.

FIG. 8 is a flowchart of a RF testing method according to another embodiment of the disclosure.

### DETAILED DESCRIPTION OF DISCLOSED EMBODIMENTS

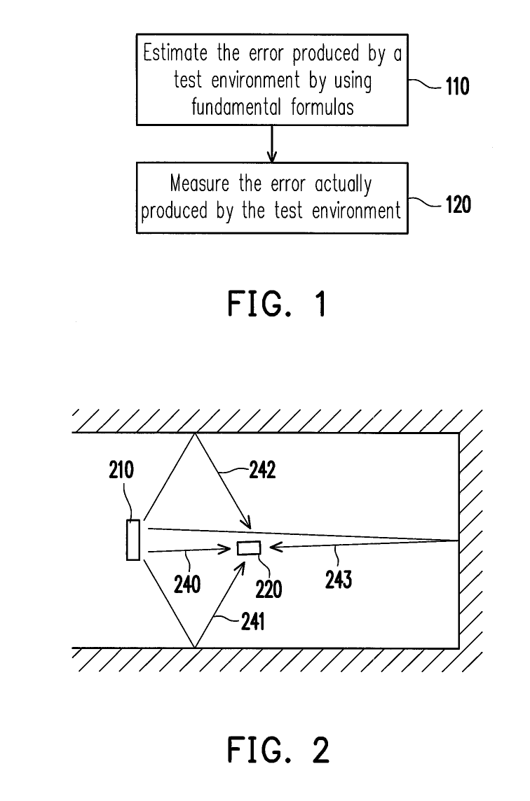

FIG. 1 is a flowchart of a radio frequency (RF) testing method according to an embodiment of the disclosure. This RF testing method can help to evaluate the range of errors produced by a test environment other than an anechoic chamber so that a user can select or design a test environment with less error. By adopting the method and apparatus of RF testing provided by embodiments of the disclosure, a user can flexibly select and establish a test environment other than an anechoic chamber through estimation, detection, correction, and detection again and perform RF testing within an estimated range of tolerance.

In step 110, the error produced by a test environment is estimated by using fundamental formulas, and in step 120, the error actually produced by the test environment is measured.

Please refer to FIG. 2 before foregoing two steps are explained. FIG. 2 is a diagram illustrating a test environment according to an embodiment of the disclosure. In the test environment illustrated in FIG. 2, a transmitter (not shown) transmits a wireless signal to a receiver 220 through a transmitting antenna 210 of the transmitter. If aforementioned RF testing is to test the starting power of a radio frequency identification (RFID) tag, the transmitting antenna 210 is the transmitting antenna of a RFID tag reader, the receiver 220 is a RFID tag under test or any other tag under test (for example, a representative tag described later), and the wireless signal transmitted by the transmitting antenna 210 is a signal used for reading the RFID tag.

Because the transmitting antenna 210 has its radiation characteristics and many objects in a non-ideal environment reflect the wireless signal, the wireless signal received by the receiver 220 is actually a superposed result of wireless signals coming from different directions. These directions include a direction 240 from the transmitting antenna 210 directly to the receiver 220, a direction 241 to the receiver 220 through the reflection of a floor, a direction 242 to the receiver 220 through the reflection of a ceiling, and a direction 243 to the receiver 220 through the reflection of a wall. When the test is performed in an anechoic chamber, there is no wireless signal from the directions 241-243 but only the wireless signal from the direction 240. In the non-ideal environment illustrated in FIG. 2, the wireless signals from the directions 241-243 respectively have their own amplitudes and phase differences and will disturb the wireless signal from the direction 240. Thus, testing errors will be produced, and this is the drawback of a non-ideal environment other than an anechoic chamber. In the non-ideal environment, common objects that reflect RF signals may include nearby walls, floors, ceilings, vehicles, utility poles, street lamps, and any other reflective objects.

In step 110, because different RF signal reflection characteristics, sizes, and surface structures of different objects in the test environment may result in different intensities of the reflected signals and a very complicated combination is produced by foregoing factors, it is very difficult to achieve an accurate estimation. The Friis transmission equation can be used as the fundamental formula of step 110 to calculate the approximation of error caused by signal reflection. The maximum error produced by signal reflection in each direction in the test environment can be calculated by using the Friis transmission equation as long as the gain of the transmitting antenna at different angle, the reflection coefficient, and the distances of reflective objects in each direction are already determined. The Friis transmission equation is an existing technique therefore will not be described herein. If a very intensive reflection signal is detected according to foregoing calculation result, an absorber can be placed in the corresponding direction to adjust the test environment, and the attenuation of the absorber is brought into the calculation.

In step 110 illustrated in FIG. 1, the errors caused by signal reflection are estimated by using a fundamental formula so that which objects in a test environment produce the most serious reflection interference and whether the error caused by signal reflection is within the tolerable range can be evaluated. Namely, whether a non-ideal test environment is usable can be preliminarily determined. However, as described above, errors estimated in step 110 are only approximations. Thus, in step 120, the errors actually caused by environmental reflection have to be measured so that whether a test environment is usable can be determined based on the actual data.

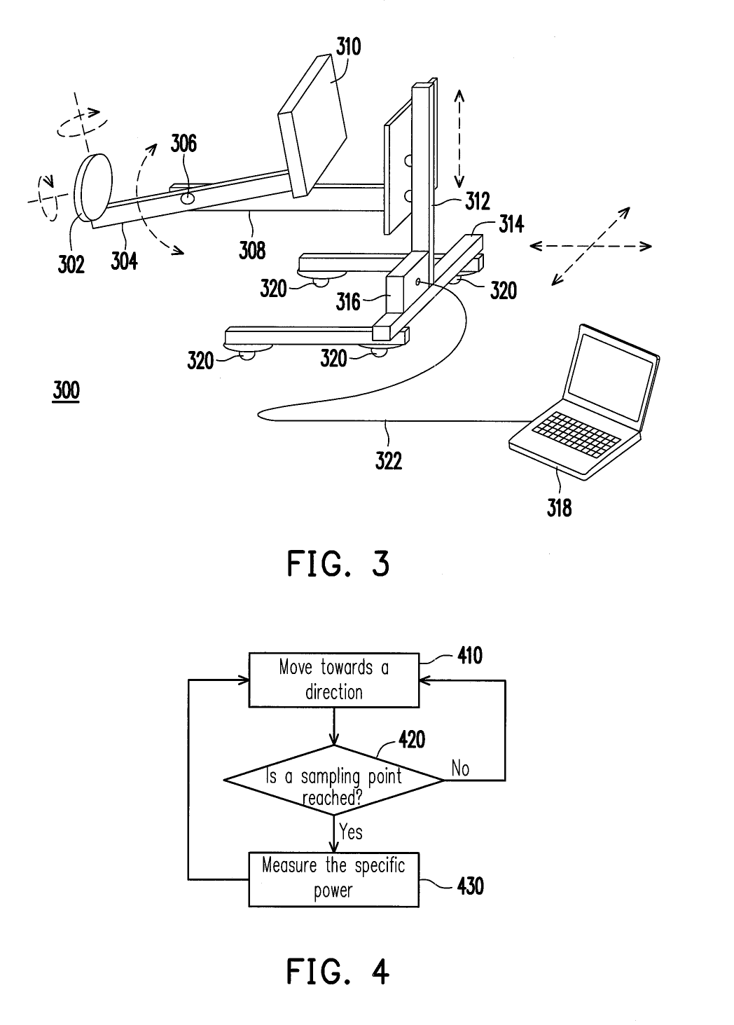

FIG. 3 is a diagram of a RF testing apparatus 300 according to an embodiment of the disclosure. The RF testing apparatus 300 can automatically execute the actual measurement in step 120 in a test environment other than an anechoic chamber. The RF testing apparatus 300 includes a carrier 302, a rotating arm 304, a moving arm 308, a transmitting antenna 310 of a transmitter, a vertical shaft 312, a base 314, a plurality of wheels 320, a driving module 316, a signal transmission line 322, and a control unit 318. A receiver is fastened on the carrier 302, and the transmitter transmits a wireless signal to the receiver through the transmitting antenna 310, so as to perform a RF testing. The receiver is corresponding to the receiver 220 in FIG. 2, and the transmitting antenna 310 is corresponding to the transmitting antenna 210 in FIG. 2. The transmitter is under the control of the control unit 318. The transmitter may be fixed on and move with the base 314, or the transmitter may be, as the control unit 318, independent of the base 314 or directly integrated with the control unit 318.

The carrier 302 and the transmitting antenna 310 are both fastened to the rotating arm 304. The rotating arm 304 is pivoted to the moving arm 308 at a pivot point 306. The moving arm 308 can slide vertically along the vertical shaft 312. The vertical shaft 312 is fastened on the base 314. The wheels 320 are disposed at the bottom of the base 314. The control unit 318 is coupled to the driving module 316 through the signal transmission line 322. The driving module 316 drives the wheels 320 to move towards different directions on the floor, drives the moving arm 308 to move vertically along the vertical shaft 312, or drives the rotating arm 304 and the carrier 302 to rotate according to instructions of the control unit 318.

The vertical movement of the moving arm 308 and the horizontal movement of the wheels 320 provide a movement freedom along three axes. The rotating arm 304 rotates around the pivot point 306, and the carrier 302 has a rotational freedom along two axes. As shown in FIG. 3, a rotation axis of the rotating arm 304 is perpendicular to two rotation axes of the carrier 302 so that a rotational freedom along three axes is provided. This is beneficial to the RF testing. For example, the starting power of a RFID tag needs to be tested from different angles.

The control unit 318 controls aforementioned movements and rotations to carry out the actual measurement in step 120. In the present embodiment, the control unit 318 is a notebook computer or any type of processor. However, the type of the control unit 318 is not limited in the disclosure. The signal transmission line 322 between the control unit 318 and the driving module 316 may also be replaced by a wireless connection.

FIG. 3 is only a diagram of the RF testing apparatus 300 but does not illustrate any structural details for accomplishing aforementioned movements and rotations. Since these structural details can be implemented with existing techniques, they will not be described herein.

In step 110, the actual measurement of step 120 has to be carried out regarding each reflective object with serious reflection interference. To be specific, regarding each reflective object, the transmitting antenna and the receiver are moved closer to or away from the object. A plurality of sampling points is predetermined according to the wavelength of the wireless signal, and a specific power is measured at each sampling point. The specific power may be a minimum transmitting power of the transmitter which allows the receiving power of the receiver for receiving the wireless signal to reach a predetermined threshold. Such an actual measurement can separate and obtain the testing error caused by each reflective object among many reflective objects in an entire test environment, so as to allow a user to evaluate the test environment.

Besides performing movement measurement regarding each reflective object, movement measurement may also be performed regarding the axes X, Y, and Z of the test environment. To be specific, the specific power may be measured at each predetermined sampling point by moving along only one of the three axes.

FIG. 4 is a flowchart of step 120 performed by the RF testing apparatus 300. First, the receiver is fastened on the carrier 302. Then, the driving module 316 drives the wheels 320 to move the base 314 according to instructions of the control unit 318, so that the carrier 302 and the transmitting antenna 310 fixed on the rotating arm 304 move together towards a direction (step 410). As described above, the direction may be a direction closer to or away from a specific reflective object or a direction parallel to one of the axes X, Y, and Z. The control unit 318 checks whether the base 314 has been moved to one of a plurality of predetermined sampling points (step 420). If the base 314 has not been moved to any sampling point, the process returns to step 410 to move the base 314 again. If the base 314 has been moved to a sampling point, the control unit 318 measures the specific power (step 430). After that, step 410 is executed again to move towards the next sampling point.

In the moving and measuring process illustrated in FIG. 4, the relative distance and the relative azimuth angle between the receiver and the transmitting antenna 310 remain unchanged, and the frequency of the wireless signal transmitted by the transmitting antenna 310 also remains unchanged, so that the measurement of the specific power is kept meaningful. The process in FIG. 4 has to be performed once regarding each reflective object in the test environment that has serious reflection interference or performed once regarding each axis of the test environment. The distance to only one reflecting object can change during the moving and measuring process, while the distance to the other reflecting objects remain constant or have changed only for a fraction of the wavelength of the wireless signal. This is required to extract the magnitude of one object's interference.

If step 120 is performed to actually measure the starting power of a RFID tag, the receiver is a RFID tag under test (referred to as a tag under test thereinafter) or a representative tag for correction purpose (will be explained later on), the transmitter is a RFID tag reader, and the wireless signal is a signal required by the RFID tag reader for reading the tag under test or the representative tag. If the receiver is a tag under test, the threshold of the specific power is the starting power of the tag under test. If the receiver is a representative tag, the threshold of the specific power is the starting power of the representative tag. Thus, the specific power is the minimum transmitting power of the RFID tag reader which allows the receiving power of the tag under test or the representative tag for receiving the wireless signal to reach the starting power thereof.

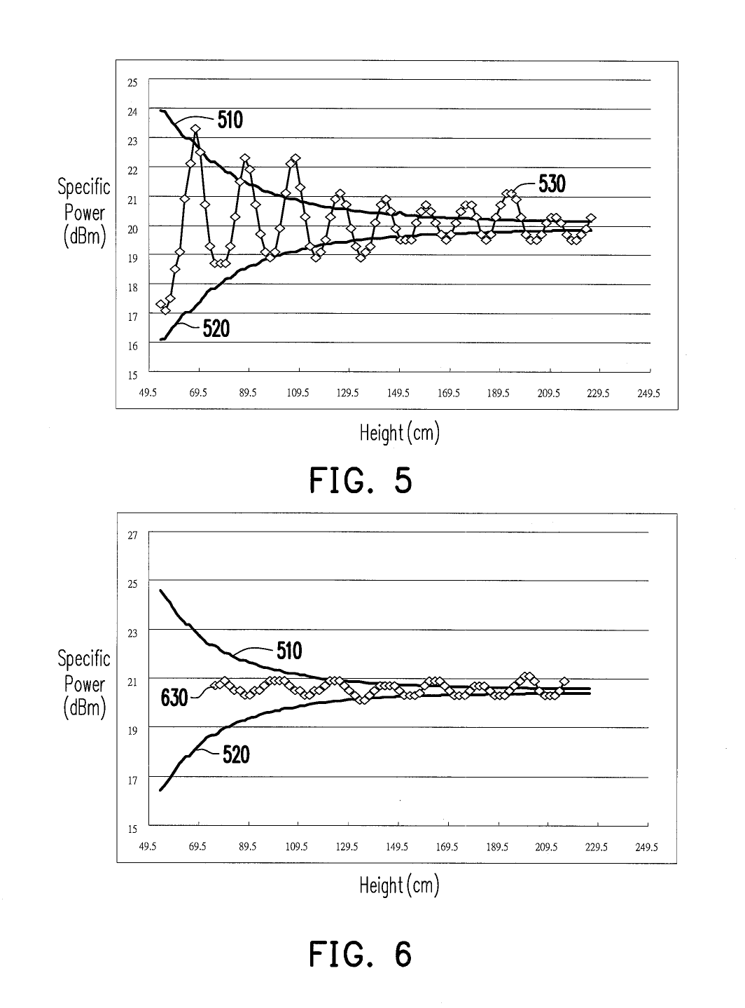

For example, if the starting power of a RFID tag is measured in an open test environment (for example, a parking space), reflection signals are mostly from the ground. In this case, sampling points are predetermined at different heights from the ground, and the moving arm 308 of the RF testing apparatus 300 is controlled to move vertically to measure the specific power at each sampling point, wherein the measurement data is illustrated in FIG. 5. Referring to FIG. 5, the vertical axis indicates the specific power, and the unit thereof is dBm, and the horizontal axis indicates the distance from the transmitting antenna and the tag under test (or the representative tag) to the ground, and the unit thereof is centimetre (cm). The curves 510 and 520 respectively represent the upper and lower limits of the specific power obtained in step 110 by using the fundamental formula, and the difference between the curves 510 and 520 represents the error range of the specific power obtained through theoretical calculation. The curve 530 represents the specific power obtained through actual measurement in step 120, and the vertical fluctuation of the curve 530 represents the error range of the specific power obtained through actual measurement. The curves 530 vertically fluctuate because the changes in the distance to the reflective object (the ground) cause the phase difference between the wireless signal and the reflection signal to change, and the waveforms of the two signals superpose or offset each other along with such changes. When the waveforms superpose each other, a lower specific power is required to start the tag under test or the representative tag, and when the waveforms offset each other, a higher specific power is required to start the tag under test or the representative tag. As shown in FIG. 5, the error caused by signal reflection gradually converges along with the increase of the distance to the reflective object. Namely, the variation range of the specific power narrows, and accordingly, the data obtained through measurement becomes more accurate, along with the increase of aforementioned distance.

If a user still finds the reduced error range too large to be accepted, the user can try to move the reflective object or place an absorber at a key location between the transmitting antenna and the reflective object. The location of the absorber should allow the wireless signal reflected by the reflective object to be eliminated. For example, the absorber can be placed on the ground under the transmitting antenna and the tag under test (or the representative tag) to attenuate the reflection signal. FIG. 6 shows the measurement result when an absorber is placed in the test illustrated in FIG. 5, wherein the vertical axis also indicates the specific power, and the horizontal axis also indicates the height of the transmitting antenna and the tag under test (or the representative tag) to the ground. The curve 630 represents the specific power obtained through actual measurement in step 120 after the absorber is placed. As shown in FIG. 6, by placing the absorber, the error range of the specific power is reduced and the test environment becomes more ideal. Foregoing step of actual measurement after placing the absorber can be used for evaluating whether the current absorber can improve the test environment.

If the reflective object is movable, the results illustrated in FIG. 5 and FIG. 6 can also be obtained by keeping the RF testing apparatus 300 still but moving the reflective object to measure the specific power. Through the actual measurement illustrated in FIG. 5 and FIG. 6, the signal reflection characteristic and the contribution to the testing error of the starting power of the tag under test of any one of many reflection sources can be captured. When a test location is selected or an absorber is placed, it is acceptable as long as the error range of the specific power obtained through actual measurement is reduced to an acceptable extent.

In order to obtain an accurate and meaningful result through aforementioned actual measurement, it should be ensured that the phase difference of only one reflection signal among the many reflection signals in the test environment changes along with the movement of the RF testing apparatus 300 or the reflective object, and the reflection signal to be captured among all the reflection signals should be smaller than the sum of other reflection signals and the main signal transmitted by the transmitting antenna.

As described above, whether a test environment other than an anechoic chamber is usable can be determined through the calculation in step 110 and the actual measurement in step 120. Through the RF testing method illustrated in FIG. 1, a user can respectively analyze the environmental reflection in each direction and calculate the maximum error produced by the test environment, so as to determine whether the test environment is up to the testing standard. Through the RF testing method in FIG. 1, a user can also determine an optimal distance between the test location and each reflective object or an optimal test location within the entire test environment, so as to control the measurement error to be within a tolerable range.

If the measurement error cannot be controlled to be within the tolerable range, the reflective object can be moved or an absorber can be placed at a key location to improve the test environment. After that, the actual measurement in step 120 is performed again. Or another test environment may be directly selected. When the maximum error obtained through the actual measurement is within the tolerable range, the test environment is usable. Even though such a test is less accurate than that performed in an anechoic chamber, the measurement error can be controlled to be within a tolerable and fixed range, and the test offers a far lower cost and is more convenient than that performed in an anechoic chamber.

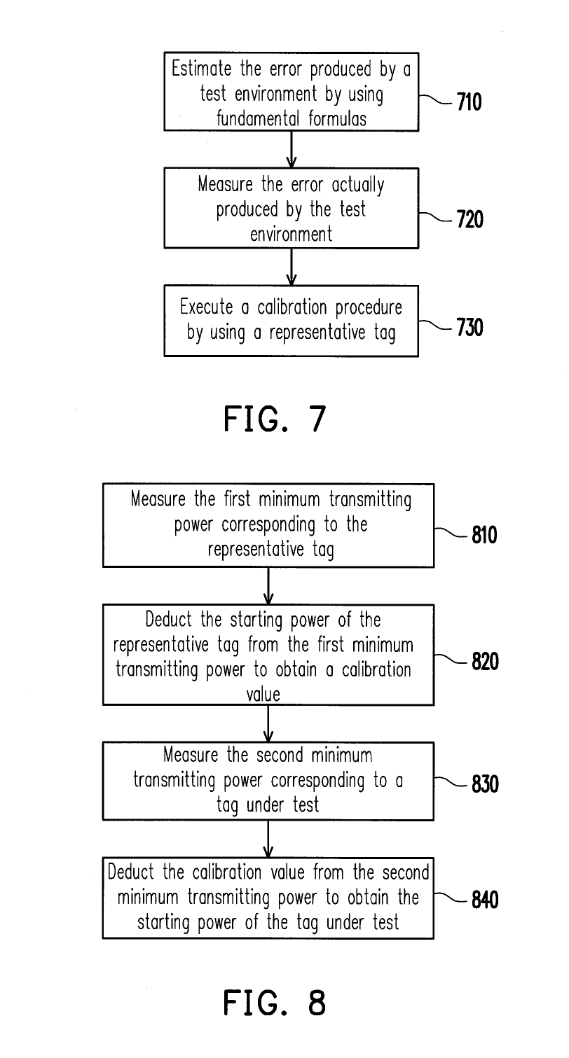

FIG. 7 is a flowchart of a RF testing method according to another embodiment of the disclosure, wherein steps 710 and 720 are respectively the same as steps 110 and 120 in FIG. 1. The main difference between FIG. 7 and FIG. 1 is that after whether the test environment is usable is determined in step 720, the control unit 318 executes a correction procedure by using a representative tag, so as to calculate the starting power of the tag under test (step 730). The representative tag is another RFID tag, and the starting power of the representative tag has been measured in an anechoic chamber therefore is an existing accurate value. The starting power of the tag under test can be measured more accurately by using the representative tag.

FIG. 8 is a flowchart of step 730 executed by the control unit 318. First, the representative tag is fastened on the carrier 302. The control unit 318 measures the first minimum transmitting power Pᵣ₁ of the RFID tag reader which allows the receiving power of the representative tag for receiving the wireless signal to reach the starting power of the representative tag (step 810). Next, the control unit 318 deducts the starting power Pₜₒ₁ of the representative tag from the first minimum transmitting power Pᵣ₁ to obtain a calibration value P_{ca1} (step 820). After that, the tag under test is tested. First, the tag under test is fastened on the carrier 302 (step 830). The control unit 318 measures the second minimum transmitting power Pᵣ₂ of the RFID tag reader which allows the receiving power of the tag under test for receiving the wireless signal to reach the starting power of the tag under test (step 830). Next, the control unit 318 deducts the calibration value P_{ca1} from the second minimum transmitting power Pᵣ₂ to obtain the starting power Pₜₒ₂ of the tag under test (step 840). The procedure illustrated in FIG. 8 can be expressed with following expressions (1) and (2):

P_{ca1}=Pᵣ₁−Pₜₒ₁ (1)

Pₜₒ₂=Pᵣ₂−P_{ca1} (2)

The control unit 318 can control the RFID tag reader to gradually increase its transmission power from the minimum transmitting power or measure the minimum transmitting powers Pᵣ₁ and Pᵣ₂ through binary search. The starting power of the tag under test calculated through the procedure in FIG. 8 is more accurate than that calculated by adopting a non-representative tag.

The procedure in FIG. 8 has to be carried out at a fixed location, and no movement is allowed during the procedure. In addition, the antenna of the tag under test and the antenna of the representative tag have to have the same polarizations and similar gains at each angle and should satisfy at least following conditions. If the RFID tag reader cannot read one of the representative tag and the tag under test at a specific azimuth angle, the RFID tag reader cannot read the other one of the representative tag and the tag under test at this azimuth angle. The tag under test may be attached to a specific product or any other test object to measure the starting power of the tag under test, and in this case, the representative tag and the tag under test attached on the test object should satisfy similar conditions.

The procedure in FIG. 8 is carried out in a non-ideal test environment other than an anechoic chamber. Because of the interference of the reflection signals, the minimum transmitting powers Pᵣ₁ and Pᵣ₂ obtained through the procedure in FIG. 8 have different values as those obtained in an anechoic chamber. However, because the minimum transmitting powers Pᵣ₁ and Pᵣ₂ are obtained at the same location in the same test environment and the antenna gains of the representative tag and the tag under test satisfy foregoing similar conditions, the same calibration value P_{ca1} is applicable to both the representative tag and the tag under test, and an accurate starting power Pₜₒ₂ of the tag under test can be obtained by using foregoing expressions (1) and (2).

The accuracy of testing in a reflective non-ideal environment can be greatly improved by using a representative tag. Even though the starting power of the representative tag needs to be measured in an anechoic chamber, the same representative tag can be used for testing the starting powers of different tags under test in a test environment other than an anechoic chamber as long as foregoing similar conditions are satisfied. In general, the testing cost can still be reduced and a tag can be tested accurately.

To a product manufacturer or supplier, a RFID tag is usually attached to a product. Thus, in step 830 illustrated in FIG. 8, the tag under test and the test object are both fastened on the carrier 302 as a receiver. In this case, the location of the tag under test has to be exactly the same as that of the representative tag in step 810. Thus, the performance of the RFID tag can be thoroughly tested by testing the tag under test and the product to which the tag under test is attached to together.

A RFID tag may be tested by using RF signals of different frequencies from different angles or locations. The control unit 318 controls the rotating arm 304 and the carrier 302 to rotate to different angles or control the transmitter to transmit wireless signals of different frequencies according to different user requirements, so as to thoroughly test the RFID tag and the product to which the RFID tag is attached to. Thus, in FIG. 8, the correction procedure in steps 810 and 820 and the tag testing performed in steps 830 and 840 can both be carried out with wireless signals of different frequencies at different locations or angles.

The RF testing method and RF testing apparatus provided in the embodiments described above are applicable to testing of the starting power of a RFID tag in an open environment. However, the RF testing method and RF testing apparatus in the disclosure are not limited to the testing of a RFID tag. The RF testing method and the RF testing apparatus provided by the disclosure can be applied as long as a transmitter and a receiver are adopted. For example, aforementioned RFID tag reader can be replaced by a test signal generator, and aforementioned RFID tag can be replaced by a power meter (power meter and a receiving antenna thereof. In this case, the receiver is the receiving antenna of the power meter, and the transmitter is the test signal generator. The specific power is defined as the receiving power of the receiving antenna for receiving the wireless signal detected by the power meter when the test signal generator transmits the wireless signal with a fixed power. The actual measurement in steps 120 and 720 can also be applied to this testing technique.

The testing technique using the test signal generator and the power meter described in foregoing embodiment can also be used for evaluating the materials of the RF testing apparatus in FIG. 3. For example, the RF testing apparatus may be constructed by using inexpensive materials or even wood materials containing iron nails, and whether such materials can make the testing error to be within a tolerable range may be determined through the testing technique by using the test signal generator and the power meter. The testing technique using the test signal generator and the power meter described in foregoing embodiment may also be used for measuring the RF reflection characteristic of a signal object in a complicated environment containing many reflective objects.

In summary, in the embodiments described above, a user can flexibly select or design a low-cost and usable test environment other than an anechoic chamber so as to perform various RF testing. Through the RF testing method and RF testing apparatus provided by foregoing embodiments, a user can evaluate the error produced by signal reflection in a test environment and various adjustments done to the test environment, so as to control the error to be within a tolerable range. Because no anechoic chamber is required in foregoing embodiments, no professional specialist or costly equipment is required, so that the testing cost can be reduced. In addition, in foregoing embodiments, a correction procedure can be performed by using a representative tag, so that the starting power of a RFID tag can be accurately measured even in an environment with signal reflections.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A radio frequency (RF) testing method, comprising:
controlling a receiver and a transmitting antenna of a transmitter to move towards a direction, wherein the transmitter transmits a wireless signal to the receiver through the transmitting antenna; and
measuring a specific power every time when one of a plurality of predetermined sampling points is reached, wherein the specific power is a minimum transmitting power of the transmitter which allows a receiving power of the receiver for receiving the wireless signal to reach a threshold, or the specific power is the receiving power of the receiver for receiving the wireless signal when the transmitter transmits the wireless signal with a fixed power, and in the steps of controlling the receiver and the transmitting antenna to move towards the direction and measuring the specific power, a relative distance and a relative azimuth angle between the receiver and the transmitting antenna remain unchanged, and a frequency of the wireless signal also remains unchanged.

2. The RF testing method according to claim 1, wherein the receiver comprises a radio frequency identification (RFID) tag, the transmitter is a RFID tag reader, the wireless signal is a signal required by the RFID tag reader for reading the RFID tag, the threshold is a starting power of the RFID tag, the specific power is a minimum transmitting power of the RFID tag reader which allows a receiving power of the RFID tag for receiving the wireless signal to reach the starting power of the RFID tag.

3. The RF testing method according to claim 2, wherein the RFID tag is a representative tag, and a starting power of the representative tag is already measured in an anechoic chamber.

4. The RF testing method according to claim 2 further comprising:
calculating a starting power of a tag under test by using a representative tag, wherein the representative tag and the tag under test are both RFID tags, and a starting power of the representative tag is already measured in an anechoic chamber.

5. The RF testing method according to claim 4, wherein the step of calculating the starting power of the tag under test comprises:
measuring a first minimum transmitting power of the RFID tag reader which allows a receiving power of the representative tag for receiving the wireless signal to reach the starting power of the representative tag;
deducting the starting power of the representative tag from the first minimum transmitting power to obtain a calibration value;
measuring a second minimum transmitting power of the RFID tag reader which allows a receiving power of the tag under test for receiving the wireless signal to reach the starting power of the tag under test;
deducting the calibration value from the second minimum transmitting power to obtain the starting power of the tag under test.

6. The RF testing method according to claim 4, wherein when the RFID tag reader is not able to read one of the representative tag and the tag under test at a specific azimuth angle, the RFID tag reader is not able to read the other one of the representative tag and the tag under test at the specific azimuth angle

7. The RF testing method according to claim 4, wherein the tag under test is attached on a test object.

8. The RF testing method according to claim 1, wherein the receiver comprises a receiving antenna of a power meter, the transmitter is a test signal generator, the specific power is a receiving power of the receiving antenna for receiving the wireless signal when the test signal generator transmits the wireless signal with the fixed power, and the power meter measures the receiving power.

9. The RF testing method according to claim 1, wherein an object exists in the direction, and the object reflects the wireless signal to the receiver.

10. The RF testing method according to claim 1, wherein an object and an absorber exist in the direction, and a location of the absorber allows the absorber to eliminate the wireless signal reflected by the object.

11. The RF testing method according to claim 9, wherein the direction comprises a direction closer to or away from the object or a direction parallel to one of axes X, Y, and Z.

12. A radio frequency (RF) testing apparatus, comprising:
a carrier, wherein a receiver is fastened on the carrier;
a transmitting antenna of a transmitter, wherein the transmitter transmits a wireless signal to the receiver through the transmitting antenna;
a driving module; and
a control unit, wherein the driving module drives the carrier and the transmitting antenna to move towards a direction according to instructions of the control unit, and the control unit measures a specific power every time when one of a plurality of predetermined sampling points is reached, wherein the specific power is a minimum transmitting power of the transmitter which allows a receiving power of the receiver for receiving the wireless signal to reach a threshold, or the specific power is the receiving power of the receiver for receiving the wireless signal when the transmitter transmits the wireless signal with a fixed power, and during the procedures of driving the carrier and the transmitting antenna to move towards the direction and measuring the specific power, a relative distance and a relative azimuth angle between the receiver and the transmitting antenna remain unchanged, and a frequency of the wireless signal also remains unchanged.

13. The RF testing apparatus according to claim 12, wherein the receiver comprises a radio frequency identification (RFID) tag, the transmitter is a RFID tag reader, the wireless signal is a signal required by the RFID tag reader for reading the RFID tag, the threshold is a starting power of the RFID tag, the specific power is a minimum transmitting power of the RFID tag reader which allows a receiving power of the RFID tag for receiving the wireless signal to reach the starting power of the RFID tag.

14. The RF testing apparatus according to claim 13, wherein the RFID tag is a representative tag, and a starting power of the representative tag is already measured in an anechoic chamber.

15. The RF testing apparatus according to claim 13, wherein the control unit calculates a starting power of a tag under test by using a representative tag, the representative tag and the tag under test are both RFID tags, and a starting power of the representative tag is already measured in an anechoic chamber.

16. The RF testing apparatus according to claim 15, wherein the control unit measures a first minimum transmitting power of the RFID tag reader which allows a receiving power of the representative tag for receiving the wireless signal to reach the starting power of the representative tag when the representative tag is fastened on the carrier, deducts the starting power of the representative tag from the first minimum transmitting power to obtain a calibration value, measures a second minimum transmitting power of the RFID tag reader which allows a receiving power of the tag under test for receiving the wireless signal to reach the starting power of the tag under test when the tag under test is fastened on the carrier, and deducts the calibration value from the second minimum transmitting power to obtain the starting power of the tag under test.

17. The RF testing apparatus according to claim 15, wherein when the RFID tag reader is not able to read one of the representative tag and the tag under test at a specific azimuth angle, the RFID tag reader is not able to read the other one of the representative tag and the tag under test at the specific azimuth angle.

18. The RF testing apparatus according to claim 15, wherein the tag under test is attached on a test object.

19. The RF testing apparatus according to claim 12, wherein the receiver comprises a receiving antenna of a power meter, the transmitter is a test signal generator, the specific power is a receiving power of the receiving antenna for receiving the wireless signal when the test signal generator transmits the wireless signal with the fixed power, and the power meter measures the receiving power.

20. The RF testing apparatus according to claim 12, wherein an object exists in the direction, and the object reflects the wireless signal to the receiver.

21. The RF testing apparatus according to claim 20, wherein an object and an absorber exist in the direction, and a location of the absorber allows the absorber to eliminate the wireless signal reflected by the object.

22. The RF testing apparatus according to claim 20, wherein the direction comprises a direction closer to or away from the object or a direction parallel to one of axes X, Y, and Z.
